(19) United States
(12) Patent Application Publication
(10) Pub. No.: US 2009/0007850 A1
(43) Pub. Date: Jan. 8, 2009

(54) Milking Member for an Animal

(75) Inventor: Raza Mehinovic, Tumba (SE)

Correspondence Address: HOVEY WILLIAMS LLP, 10801 Mastin Blvd., Suite 1000, Overland Park, KS, 66210, US

(73) Assignee: DELAVAL HOLDING AB, Tumba (SE)

(21) Appl. No.: 11/813,581

(22) PCT Filed: Dec. 30, 2005
(86) PCT No.: PCT/SE2005/002064

§ 371 Date: May 16, 2008

(30) Foreign Application Priority Data
Jan. 10, 2005 (SE) SE0500042-7

(51) Int. Cl. A01J 5/04

(52) U.S. Cl. 119/14.54

(57) ABSTRACT

The invention relates to a milking member for an animal. The milking member comprises a claw (1), a plurality of teat cups (3a-d), a plurality of milk conduits (2a-d), which each is connected to the claw (1) at a first end and to a teat cup (3a-d) at a second end, and means, which makes it possible to hold the respective teat cups (3a-d) in a substantially upright positions on a level above the claw (1) when the milking member not is attached to an animal. Said means comprises milk conduits (2a-d), which have a stiffness such that they are able to hold the respective teat cups (3a-d) in said upright positions on a level above the claw (1) when the teat cups (3a-d) not are attached to the teats of an animal.

### BACKGROUND OF THE INVENTION AND PRIOR ART

The present invention relates to a milking member to be attached to an animal, wherein the milking member comprises a claw, a plurality of teat cups, a plurality of milk conduits, which each is connected to the claw at a first end and to a teat cup at a second end, and means, which makes it possible to hold the respective teat cups in a substantially upright positions on a level above the claw when the milking member not is attached to an animal.

It is in many aspects favorable to hold the teat cups of a milking member in upright positions and on a level above the claw when the teat cups not is attached to an animal. With such a positioning of the teat cups, it is easy for an operator or a milking robot to grip and attach the teat cups to the teats of the animal. Furthermore, the teat cups are prevented to come in contact with the ground during the process when the milking member is attached to the animal and during the process when the milking member is retracted from the animal. Consequently, with such a positioning of the teat cups, the teat cups become less dirty than the teat cups of a conventional milking member.

U.S. Pat. No. 5,950,561 shows a milking machine with a storage system in which the teat cups are held in upright positions on a level above the claw when they not are attached to an animal. The storage system comprises additional components such as, for example, flexible chains, telescopic arms, adjustable rods and frame members. The use of such components result in a complex construction and it is a risk that said components get entangled with other components or with the animal to be milked.

### SUMMARY OF THE INVENTION

The object of the present invention is to provide a milking member for an animal, which is able to hold the teat cups in upright positions on a level above the claw in a simple and effective manner without the use of additional components.

This object is obtained according to the invention by the feature that said means comprises milk conduits, which have a stiffness such that the they are able to hold the respective teat cups in said upright positions on a level above the claw when the teat cups not are attached to the teats of the animal. Thereby, a simple construction of the milking member is achieved without the use of additional components for holding the teat cups in upright positions above the claw when the teat cups not are attached to the teats of an animal. Preferably, the milk conduits have a sufficient stiffness for holding the teat cups in upright positions but, at the same, they have time an elasticity such that it is easy move the teat cups to positions where they are attachable to the teats of an animal. Such a relatively stiff milking member is relatively compact and it easy to handle for an operator or a milking robot. The upright positions of the teat cups guarantee that the teat cups do not come in contact with the ground and become dirty during the attachment process of the milking member to an animal and during the retraction process of the milking member from an animal.

According to a preferred embodiment of the invention, the milk conduits are arranged to hold the teat cups in mutual positions, which substantially correspond to the mutual positions of the teats of the animal to be milked. The mutual positions of the teats may be based on information of the average distances between the teats of the animals to be milked. In such a case, the teat cups may be attached to the teats of substantially all animals with relatively small mutual motions of the teat cups from its original positions. Such a positioning of the teat cups of the milking member result in an easy attachment of the teat cups and that a good engagement between the teat cup liners and the teats is ensured. Said means may comprise first connection members, which are arranged to enable connections between the first ends of the milk conduits and the claw such that the second ends of the milk conduits hold the teat cups in said mutual positions. When the first ends of the milk conduits are mounted in suitable direction in relation to the claw by means of the first connection members, the relatively stiff milk conduits hold the teat cups in said mutual positions. Preferably, the first connection members enable a connection of the milking conduits in mounting directions such that it is possible to use milk conduits of the milking member, which all have the same size and design. In this case, only one kind of milk conduit needs to be used. Advantageously, the first connection members comprise nipples fixedly attached to a surface of the claw. By information of the size and the design of the milk conduits to be used, it is possible to arrange the nipples on the claw in different directions such that the milk conduits, in a mounted state, hold the teat cups in said mutual positions.

According to a further embodiment of the invention, the animal to be milked is a cow and the milking member comprises four teat cups and four milk lines. However, it is possible to use the milking member for milking of other kinds of animals than cows. When the animal is a cow, the milk conduits may be arranged to hold the two teat cups, which are arranged to be attached to the front teats of the cow, on a higher level than the remaining two teat cups, which are arranged to be attached to the rear teats of the cow. It has been recognised that the front udder half of cows is higher than the rear one, i.e. the two front teats are located at a higher position than the two rear teats. When the udders are charged with milk the teats are relatively stiff and straggling and will therefore be relatively immovable in relation to these positions. Preferably, the milk conduits are arranged to hold the two teat cups, which are arranged to be attached to the front teats of the cow, at a longer distance from each other than the two teat cups, which are arranged to be attached to the rear teats of the cow. By studying the mutual positions of the teats of the udder of cows, it has been recognised that the distance between the two front teats is longer than the distance between the two rear teats. By such a positioning of the teat cups of the milking member, it is guaranteed that the liner of all teat cups close tightly against the teats of substantially all cows to be milked.

According to a further embodiment of the invention, the milk conduits are manufactured of a plastic material. Such a plastic material may comprise silicon or santopren. However, it is possible to manufacture the milk conduits in arbitrary materials, which have the suitable properties for holding the teat cups in an upright position.

According to a further embodiment of the invention, said means comprises a plurality of pulsation conduits, which each is connected to the claw at a first end and to a teat cups at a second end, wherein the pulsation conduits are manufactured of a material having a stiffness such that the pulsation conduits contribute to hold the respective teat cups in said upright positions on a level above the claw. By the use of such pulsation conduits, the teat cups may be positioned in said upright positions with an increased stability.

According to a preferred embodiment of the invention, the pulsation conduits are arranged to contribute to hold the teat cups in mutual positions, which substantially correspond to the mutual positions of the teats of the animal to be milked. Thereby, the teat cups may be positioned in said mutual positions with an increased stability. Said means may comprise second connection members, which are arranged to enable connections between the first ends of the pulsation conduits and the claw such that the second ends of the pulsation conduits contribute to hold the teat cups in said mutual positions. When the pulsation conduits are mounted in suitable direction in relation to the claw by means of the second connection members, the relatively stiff pulsation conduits contribute in an effective manner to hold the teat cups in said mutual positions. Preferably, the second connection members enable a connection of the pulsation conduits in mounting directions such that it is possible to use pulsation conduits of the milking member, which all have the same size and design. In this case, only one kind of pulsation conduit needs to be used. Advantageously, the second connection members comprise nipples fixedly attached to a surface of the claw. The nipples may have an arrangement on the surface on the claw in different directions such that the pulsation conduits, in a mounted state, contribute to hold the teat cups in said mutual positions.

According to a further embodiment of the invention, the pulsation conduits are manufactured of a plastic material. Such a plastic material may comprise silicon or santopren. However, it is possible to manufacture the pulsation conduits in arbitrary materials, which have suitable properties.

### BRIEF DESCRIPTION OF THE DRAWINGS

In the following, a preferred embodiment of the invention is described by an example and with references to the attached drawings, in which

FIG. 1 shows a perspective view of a milking member according to the invention,

FIG. 2 shows the milking member from the above and

FIG. 3 shows the claw of the milking member.

### BRIEF DESCRIPTION OF A PREFERRED EMBODIMENT OF THE INVENTION

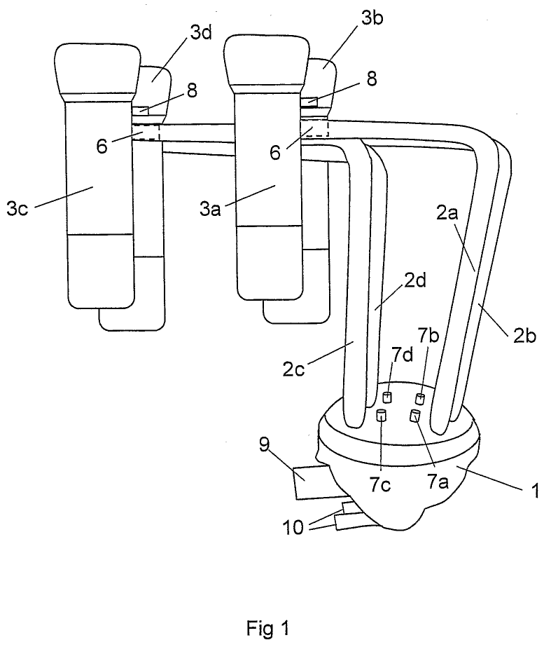

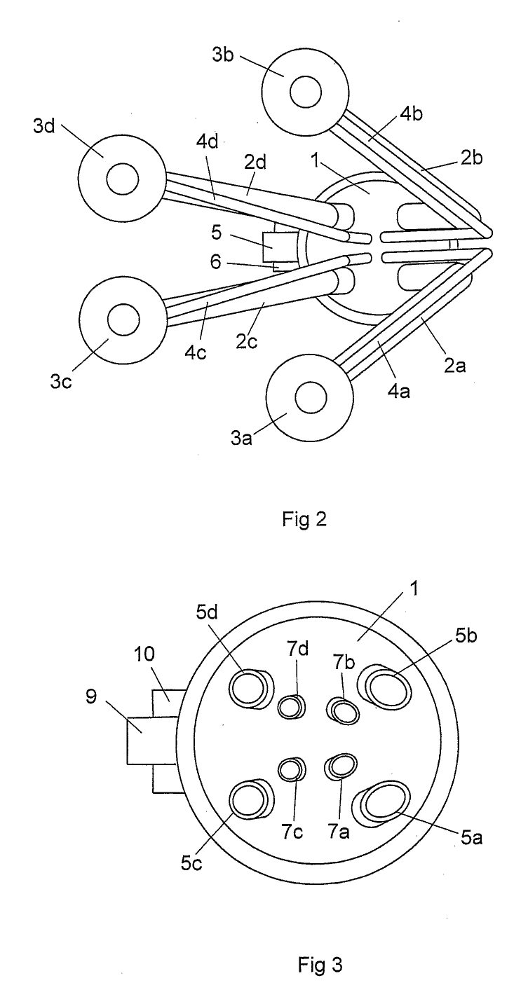

The FIGS. 1-3 shows a milking member, which is arranged to be attached to milking cows. The milking member comprises in a conventional manner a claw 1, four short milk conduits 2a-d, four teat cups 3a-d and four pulsation conduits 4a-d. The pulsation conduits 4a-d are shown only in FIG. 2. According to the invention, the short milk conduits 2a-d have a higher stiffness than conventional short milk conduits such that they substantially maintain an original shape both when the milking member is attached to a cow and when the milking member not is attached to a cow. All the milk conduits 2a-d have an identical design and size. The milk conduits 2a-d comprise a first straight portion, which is connected to the claw 1 at an end by means of nipples 5a-d arranged on an upper surface the claw 1. The short milk conduits 2a-d comprise a second straight portion, which is connected to one of the teat cups 3a-d at an end by means of nipples 6 arranged on a side surface of the teat cups 3a-d. The short milk conduits 2a-d comprise a bent portion of about 90°, which connects the first straight portion and the second straight portion. Consequently, the milk conduits 2a-d have a substantially L-shaped extension between its ends.

The four pulsation conduits 4a-d also have a higher stiffness than conventional pulsation conduits such that they substantially maintain an original shape both when the milking member is attached to a cow and when the milking member not is attached to a cow. All the pulsation conduits 4a-d are identical. The pulsation conduits 4a-d comprise a first straight portion, which is connected to the claw 1 at an end by means of nipples 7a-d arranged on an upper surface the claw 1. The pulsation conduits 4a-d comprise a second straight portion, which is connected to one of the teat cups 3a-d at an end by means of nipples 8 arranged on a side surface of the teat cups 3a-d. The pulsation conduits 4a-d comprise a bent portion of about 90°, which connects the first straight portion and the second straight portion. Consequently, the pulsation conduits 4a-d have a substantially L-shaped extension between its ends. The relatively stiff pulsation conduits 4a-d contribute in an effective manner to hold the respective teat cups 3a-d in upright positions on a level above the claw 1. A milk tube 9 is connected to a lower part of the claw 1. The milk tube 9 is arranged to transport the milk from the claw 1 to a main milk line or the like. The lower part of the claw 1 is, via vacuum tubes 10, connected to a pulsator, which not is visible in the figures.

The claw 1 has a convex upper surface. A suitable shaped convex upper surface of the claw 1 facilitates the arrangement of the nipples 5a-d and the nipples 7a-d in different positions and with different specific inclinations in relation to a horizontal plane. With such specific inclinations of the nipples 5a-d, the milk conduits 2a-d achieve, in a mounted state, extensions in different directions such that they hold the teat cups 3a-d in positions, which substantially correspond to the mutual positions of the teats of a cow. In a corresponding manner, each of the nipples 7a-d are arranged in specific positions on the upper surface of the claw 1 and with specific inclinations in relation to a horizontal plane. With such an arrangement of the nipples 7a-d, the pulsation conduits 4a-d achieves, in a mounted state, extensions in different directions such that they contribute to hold the teat cups 3a-d steady in said positions, which substantially correspond to the mutual positions of the teats of a cow.

In order to determine the specific positions and the specific inclinations of the respective nipples 5a-d, 7a-d, information about the average distances between the teats of cows may be used. Generally, the two front teats of cows are located on a higher level than the two rear teats. Therefore, it is suitable that the milk conduits 2a, b achieves an inclination such that they hold the two teat cups 3a,b, which are arranged to be attached to the front teats of the cow, on a higher level than the remaining two teat cups 3c,d, which are arranged to be attached to the rear teats of the cow. Generally, the distance between the two front teats of cows is longer than the distance between the two rear teats. Therefore, it is suitable that the milk conduits 2a, b achieves an inclination such that they hold the two teat cups 3a, b at a longer distance from each other than the two teat cups 3c, d. Consequently, by information about the average distances between the teats of cows and the design of the milk conduits 2a-d, it is possible to determine the specific positions and the specific inclinations for the nipples 5a-d, 7a-d on the upper surface of the claw 1.

The milk conduits 2a-d will at least have a stiffness such that it is possible to hold the relative light teat cups 3a-d in upright positions on a level above the claw 1. On the other hand, the milk conduits 2a-d will have an elasticity such that it is easy to move and to attach the teat cups 3a-d to cows having somewhat different mutual positions of the teats than an average cow. With a suitable elasticity of the milk conduits 2a-d, the tensions in the milk conduits 2a-d are substantially negligible when the teat cups 3a-d are attached to cows with somewhat different mutual positions of the teats than an average cow. Consequently, a good engagement between the teat cup liners and the teats of substantially all cows is guaranteed. The milk conduits 2a-d may be manufactured of a suitable plastic material and in dimensions such that they obtains the required properties.

Consequently, milk conduits 2a-d and pulsation conduits 4a-d with an identical size and shape are used to hold the teat cups 3a-d in said upright positions above the claw. Thereby, the number of different components of the milking member do not exceed the number of different components of a conventional milking member. The milking member constitutes a relatively stiff and compact unit, which in a simple manner is attachable to a cow by an operator or a milking robot. Furthermore, it is easy to retract the milking member from a cow when a milking process is ended with a suitable retracting mechanism. Since the teat cups of the milking member are in upright positions above the claw, they are prevented from get in contact with the ground and become dirty during the attachment process and the retracting process of the milking member.

The invention is not limited to the described embodiments but may be varied and modified freely within the scope of the claims. The milk conduits may have an arbitrary but functional shape. Other kinds of first and second connection members than nipples may be used. It is suitable that pulsation conduits are used, which contribute to hold the respective teat cups in said upright positions on a level above the claw but it is not necessary.

1. A milking member to be attached to an animal, wherein the milking member comprises a claw (1), a plurality of teat cups (3a-d), a plurality of milk conduits (2a-d), which each is connected to the claw (1) at a first end and to a teat cup (3a-d) at a second end, and means, which makes it possible to hold the respective teat cups (3a-d) in a substantially upright positions on a level above the claw (1) when the milking member not is attached to an animal, characterized in that said means comprises milk conduits (2a-d), which have a stiffness such that they are able to hold the respective teat cups (3a-d) in said upright positions on a level above the claw (1) when the teat cups (3a-d) not are attached to the teats of an animal.

2. A milking member according to claim 1, characterized in that the milk conduits (2a-d) are arranged to hold the teat cups (3a-d) in mutual positions, which substantially correspond to the mutual positions of the teats of the animal to be milked.

3. A milking member according to claim 2, characterized in that said means comprises first connection members (5a-d), which are arranged to enable connections between the first ends of the milk conduits (2a-d) and the claw (1) such that the second ends of the milk conduits (2a-d) hold the teat cups (3a-d) in said mutual positions.

4. A milking member according to claim 3, characterized in that the first connection members (5a-d) enable a mounting of the milking conduits (2a-d) in directions such that it is possible to use milk conduits (2a-d) of the milking member, which all have the same size and design.

5. A milking member according to any one of the claims 2 to 4, characterized in that the first connection members comprise nipples (5a-d) fixedly attached to a surface of the claw and with specific inclinations in relation to a horizontal plane.

6. A milking member according to any one of the preceding claims, characterized in that the animal to be milked is a cow and the milking member comprises four teat cups (3a-d) and four milk lines (2a-d).

7. A milking member according to claim 6, characterized in that, the milk conduits (2a,b) are arranged to hold the two teat cups (3a,b), which are arranged to be attached to the front teats of the cow, on a higher level than the remaining two teat cups (3c, d), which are arranged to be attached to the rear teats of the cow.

8. A milking member according to the claim 6 or 7, characterized in that the milk conduits (2a, b) are arranged to hold the two teat cups (3a, b), which are arranged to be attached to the front teats of the cow, at a longer distance from each other than the two teat cups (3c, d), which are arranged to be attached to the rear teats of the cow.

9. A milking member according to any one of the preceding claims, characterized in that the milk lines (2a-d) are manufactured of a plastic material.

10. A milking member according to any one of the preceding claims, characterized in that the milk lines (2a-d) have an extension between its ends, which is substantially L-shaped.

11. A milking member according to any one of the preceding claims, characterized in that said means comprises a plurality of pulsation conduits (4a-d), which each is connected to the claw (1) at a first end and to a teat cup (3a-d) at a second end, wherein the pulsation conduits (4a-d) are manufactured of a material having a stiffness such that the pulsation conduits (4a-d) contribute to hold the respective teat cups (3a-d) in said upright positions on a level above the claw (1) when the teat cups (3a-d) not are attached to the teats of an animal.

12. A milking member according to claim 2 and 11, characterized in that the pulsation conduits (4a-d) are arranged to contribute to hold the teat cups (3a-d) in mutual positions, which substantially correspond to the mutual positions of the teats of the animal to be milked.

13. A milking member according to claim 12, characterized in that said means comprises second connection members (7a-d), which are arranged to enable connections between the first ends of the pulsation conduits (4a-d) and the claw (1) such that the second ends of the pulsation conduits (4a-d) contributes to hold the teat cups (3a-d) in said mutual positions.

14. A milking member according to claim 13, characterized in that the second connection members (5a-d) enable a mounting of the pulsation conduits (4a-d) in directions such that it is possible to use pulsation conduits (4a-d) of the milking member, which all have the same size and design.

15. A milking member according to any one of the claims 12 to 14, characterized in that the second connection members comprise nipples (5a-d) fixedly attached to a surface of the claw and with specific inclinations in relation to a horizontal plane.

16. A milking member according to any one of the claims 11 to 15, characterized in that the pulsation conduits (4a-d) are manufactured of a plastic material.

17. A milking member according to any one of the claims 11 to 16, characterized in that the pulsation conduits (4a-d) have an extension between its ends, which is substantially L-shaped.
